(19) United States
(12) Patent Application Publication
(10) Pub. No.: US 2011/0059331 A1
(43) Pub. Date: Mar. 10, 2011

(54) DIVERTING A CAPILLARY FLOW OF BRAZE MATERIAL DURING A BRAZING METHOD

(76) Inventors: James G. E. Smith, Sydney (AU); Mark A. Spalding, Sydney (AU); Desmond A. McCusker, Sydney (AU); Derek I. Darley, Sydney (AU)

(21) Appl. No.: 12/878,711

(22) Filed: Sep. 9, 2010

(30) Foreign Application Priority Data
Sep. 9, 2009 (AU) 2009213037

(51) Int. Cl. B32B 3/10; B23K 1/00

(52) U.S. Cl. 428/596; 228/258

(57) ABSTRACT

A method for joining a first component to a second component with a brazing material, the first component including an aperture for receiving the second component. The method includes positioning the second component within the first component via the aperture to form a gap between an inner surface of the first component and an outer surface of the second component, introducing by capillary action brazing material into the gap between the first component and the second component, and forming a join between the first and second component upon cooling of the brazing material introduced by capillary action. According to this first aspect of the present invention, the capillary flow of brazing material in the gap is diverted via a capillary flow diverter located in the gap between the first and second component.

### CROSS-REFERENCE TO RELATED APPLICATIONS

This patent application claims priority from Australian Patent Application No. 2009-213037, entitled “Braze Join,” filed on 9 Sep., 2009, which is hereby incorporated by reference herein.

### BACKGROUND

1. Field of the Invention

The present invention relates generally to the braze joining of components, and more particularly, diverting a capillary flow of braze material during a brazing method.

2. Related Art

Often it is a requirement to join together components in an implantable medical device (IMD) to form a hermetic seal. The hermetic seal functions to prevent the ingress of bodily fluids into the IMD and/or the leakage of non biocompatible material from the interior of the IMD to the human body upon implantation of the device. One example process used to hermetically join components is the process of brazing or braze welding and a particular application of this process is the braze joining of a feedthrough component (e.g., a component that permits an electrical signal to be conducted from one side of the feedthrough component to the other side of the feed through component, as will be described in greater detail below) to another component such as the hermetically sealed body or enclosure of an IMD. Alternatively, the feedthrough component may be joined to a mounting component, such as a flange, which is in turn is joined to the body or enclosure of the IMD by a process such as laser welding or the like.

A feedthrough component typically comprises an insulating material such as ceramic or glass through which extends one or more electrically conductive elements. These conductive elements convey electrical power and/or electrical signal information essential for the operation of the IMD. With the increasing miniaturisation of IMDs, the otherwise effective process of braze joining becomes problematic. The primary problem is as a result of the relatively small size and/or small mass of one or more of the components being joined together, and as a consequence, the relatively low thermal mass of those components. As the braze joining process involves the heating of both of the components above the melting point of the relevant brazing material, this can result in substantial heat stresses applied to the components, thereby causing distortion and even fracturing or cracking of materials resulting in low yields for the braze joining process. This may also occur where a hermetic join is required.

### SUMMARY

According to a first aspect the present invention, there is a method for joining a first component to a second component with a brazing material, the first component including an aperture for receiving the second component. The method comprises positioning the second component within the first component via the aperture to form a gap between an inner surface of the first component and an outer surface of the second component, introducing by capillary action brazing material into the gap between the first component and the second component, and forming a join between the first and second component upon cooling of the brazing material introduced by capillary action. According to this first aspect of the present invention, the capillary flow of brazing material in the gap is diverted via a capillary flow diverter located in the gap between the first and second component.

According to another aspect of the present invention, there is an assembly including a first component and a second component joined together with brazing material. The assembly comprises a first component including an aperture for receiving the second component, the second component, wherein the second component located within the first component, an area between an inner surface of the first component and an outer surface of the second component, the area containing solidified braze material, the braze material joining the first component to the second component, and a capillary flow diverter sized and dimensioned to divert capillary flow of liquefied brazing material in the area during the joining of the first component and the second component. A capillary meniscus extends from the surface of the first component to the surface of the second component.

According to another aspect of the present invention, there is a method for joining a first component to a second component with a brazing material, the first component including an aperture for receiving the second component. The method comprises positioning the second component within the first component via the aperture to form a gap between an inner surface of the first component and an outer surface of the second component, stacking a plurality of braze material members at least one of about the second component or within the first component, liquefying at least a portion of the braze material members, and introducing by capillary action the brazing material into the gap between the first component and the second component.

### BRIEF DESCRIPTION OF THE DRAWINGS

Illustrative embodiments of the present invention will be discussed with reference to the accompanying drawings wherein:

FIG. 1 is a perspective sectional view of the interior components of an implantable DACS actuator;

FIG. 2 is an exploded view of an assembly including a first component and a second component of the implantable DACS actuator illustrated in FIG. 1 to be joined together in accordance with an illustrative embodiment of the present invention;

FIG. 3 is a cut away sectional perspective view of the mounting flange of the assembly illustrated in FIG. 2;

FIG. 4 is a second perspective view of the mounting flange illustrated in FIG. 3;

FIG. 5 is a perspective view of a collar member of the assembly illustrated in FIG. 2;

FIG. 6 is a perspective view of washers of brazing material forming part of the assembly illustrated in FIG. 2;

FIG. 7 is a side sectional view of the assembly illustrated in FIG. 2 as assembled prior to heating in an oven;

FIG. 8 is a top sectional view taken through section 8-8 of the assembly illustrated in FIG. 7;

FIG. 9 is a sectional view of the assembly illustrated in FIG. 7 depicting the capillary flow of brazing material in accordance with an illustrative embodiment of the present invention;

FIG. 10 is a sectional view of the mounting flange and collar member of the assembly illustrated in FIG. 7 once again depicting the capillary flow of brazing material;

FIG. 11 is a sectional perspective view of the collar member and washers of brazing material forming part of the assembly illustrated in FIG. 7;

FIG. 12 is a side perspective view depicting the location of the assembled assembly of FIG. 7 with respect to the body of the implantable DACS actuator illustrated in FIG. 1;

FIGS. 13a and 13b are top plan and perspective views of a mounting flange in accordance with an illustrative embodiment of the present invention;

FIGS. 14a and 14b are top plan and perspective views of a mounting flange in accordance with a further illustrative embodiment of the present invention;

FIGS. 15a and 15b are top plan and perspective views of a mounting flange in accordance with another illustrative embodiment of the present invention; and

FIGS. 16a and 16b are top plan and perspective views of a mounting flange in accordance with yet another illustrative embodiment of the present invention.

### DETAILED DESCRIPTION

An embodiment of the present invention includes a method for forming a braze join between components that is capable of reducing the heat effects of the brazing process on the components being joined together. An embodiment of the present invention includes a method for joining a flange to a feedthrough component with a brazing material. In this embodiment, the flange includes an aperture for receiving the feedthrough component. The method comprises positioning the feedthrough component within the flange via the aperture to form a gap between an inner surface of the flange and an outer surface of the feedthrough component, followed by introducing by capillary action brazing material into the gap between the flange and the feedthrough component. A join is then formed between the flange and the feedthrough component upon cooling of the brazing material introduced by capillary action. According to this embodiment, the capillary flow of brazing material in the gap is diverted via a capillary flow diverter located in the gap between the first and second component. Still further, according to this embodiment, solidified brazing material is initially deployed as a number of circular washers about the feedthrough component and/or in the aperture of the flange. Each of the washers includes a slit which allows the washers to be flexed when placed into position. These washers melt for form the liquefied brazing material just discussed.

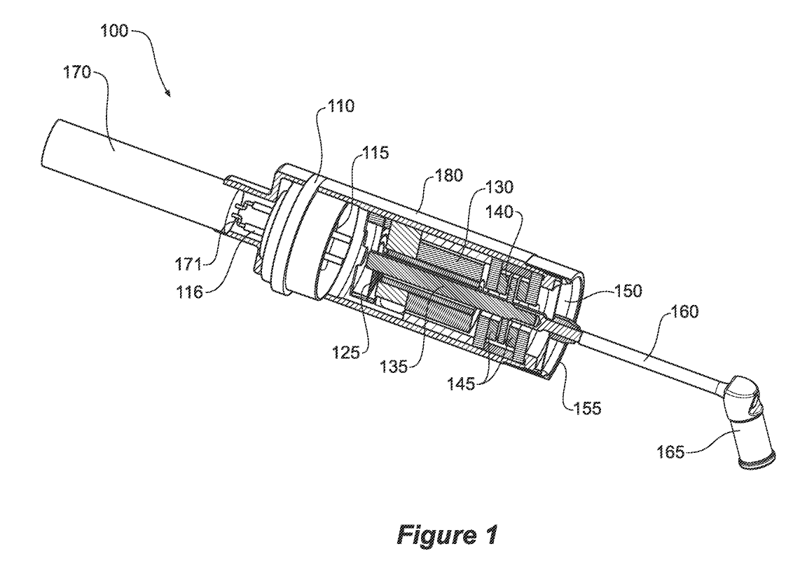

Referring to FIG. 1, there is shown an example IMD in the form of a hearing aid device incorporating a feedthrough component in which the present invention may be utilized. In this example, IMD is an actuator 100 which operates by direct acoustic cochlear stimulation (DACS) to directly stimulate the inner ear fluid (perilymph) by simulating the operation of a normally functioning middle ear. As would be apparent to those of skill in the art, the present invention will also be applicable to other IMDs such as cochlear implants (described in greater detail below), neural stimulators, internal drug pumps, incontinence devices, bone growth stimulators and the like where a hermetic join is required to be formed between components.

Embodiments of the present invention are further applicable to other types of active implantable medical devices (AIMDs), such as, auditory brain stimulators, also sometimes referred to as an auditory brainstem implant (ABI), other implanted hearing aids or hearing prostheses, retinal prostheses, cardiac related devices such as pacers (also referred to as pacemakers) or defibrillators, implanted drug pumps, other electro-mechanical stimulation devices, or other implanted electrical devices.

Actuator 100 includes a housing 180 formed from titanium tubing that is substantially cylindrical and of circular cross section. Actuator 100 further includes a titanium diaphragm 150, a titanium protection ring 155 and a multi-pin feedthrough component 115 which is joined to a mounting flange 110 which in turn is laser welded to housing 180. In this example, feedthrough component 115 is a ceramic feedthrough component formed from alumina by a powder injection moulding (PIM) process.

As would be appreciated by those of skill in the art, some embodiments of the present invention may utilize a ceramic feedthrough component as opposed to a feedthrough component of the glass type variety due to the increased density of the ceramic material and its strength of bond to biocompatible materials such as titanium, platinum and the like. In some embodiments, some or all of these features may improve the likelihood of achieving a hermetic seal that meets the strict quality requirements required of an IMD, thereby resulting in improved yields. In addition, the PIM process allows more complex geometries to be achieved as compared to other over moulding processes such as those involving glass which can be restricted by the inherent viscosity characteristics of the glass material.

Coupling rod 160, which is part of the moving mechanical output structure of electromechanical driving arrangement of actuator 100 is hermetically welded to diaphragm 150. This assembly provides a hermetically closed housing 180 that is suitable for implantation in the human body. Lead 170 which conveys the electrical input signal to actuator 100 is connected by leads 171 to contact pins 116 which extend through feedthrough component 115. Armature 140, shaft 135 and coupling rod 160 form the moving part of actuator 100 which is driven by coil 130 between permanent magnets 145 responsive to the electrical input signal from contact pins 116.

Shaft 135 is made of titanium to enable hermetic closing of actuator 100 by welding it to diaphragm 150 which also elastically supports the end of shaft 135 and performs the function of a restoring spring. As such, diaphragm 150 prevents magnetic snap over. On the other side, shaft 135 is supported in the longitudinal direction by a spring bearing 125 having a spring constant sufficient to provoke, together with diaphragm 150, the demanded dynamic characteristic of this spring-mass structure to drive artificial incus 165.

Further details of DACS actuators of the type referred to above are described in PCT Application No. PCT/AU2005/001801 (WO 2006/058368) entitled IMPLANTABLE ACTUATOR FOR HEARING AID APPLICATIONS, published 8 Jun. 2006, the details of the DACS actuators disclosed therein are usable in some embodiments of the present invention involving application to DACS.

The overall dimensions of actuator 100 are Ø3.75×9.3 mm (not including coupling rod 160 and artificial incus 165) resulting in dimensional requirements for the ceramic feedthrough component 115 of Ø2.17 mm×1.49 mm thickness which is significantly reduced when compared to the feedthrough of other IMDs. As an example, a typical cochlear implant would be expected to have dimensions in the order of Ø8.00×1 mm-2 mm thickness. Known methods of braze joining (see for example PCT Application No. PCT/AU2006/002012 (WO 2007/070989) entitled IMPROVED BRAZE JOIN, published 28 Jun. 2007, some or all of the methods, systems and apparatuses pertaining to braze joining disclosed therein usable in some embodiments of the present invention) for braze joining feedthrough component 115 to the surrounding flange 110 may result in the generation of large thermal stresses potentially resulting in the fracture or cracking of feedthrough component 115 during the brazing process.

The generation of these thermal stresses is primarily due to the small thermal mass of feedthrough component 115 which makes the brazing process especially sensitive to process variations. As an example, the total mass of the DACS actuator 100 described with reference to FIG. 1 is 0.45 grams of which the ceramic feedthrough component 115 makes up approximately 0.025 grams. In addition, smaller components have an increasingly large surface area to volume ratio, thereby adding to their propensity to overheat during the braze joining process potentially resulting in potential stress cracking of the component.

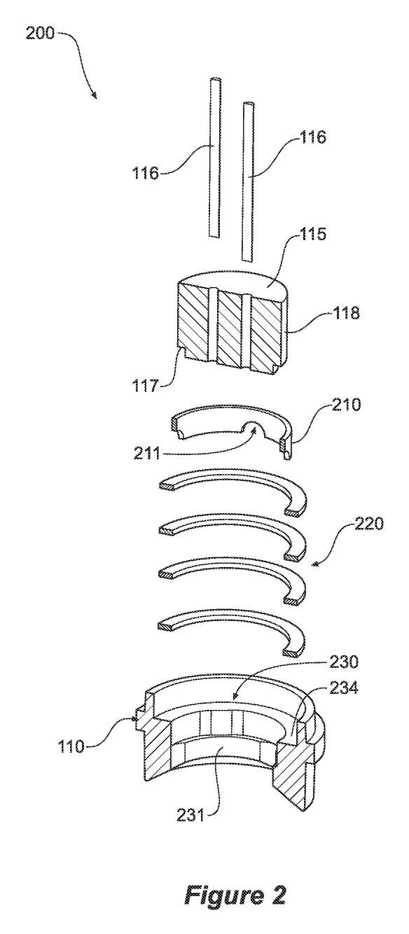

Referring now to FIG. 2, there is shown an exploded perspective view of an assembly 200 including a first component (in this example mounting flange 110) to be joined to a second component (in this example feedthrough component 115) according to a first illustrative embodiment of the present invention. Assembly 200 includes a mounting flange 110, formed in this illustrative embodiment of titanium, having an aperture 230 for receiving a feedthrough component 115 incorporating contact pins 116 which in practice would be integrated into feedthrough component 115 by a moulding process prior to joining Assembly 200 further includes a collar member 210 and four stackable circlets or washers 220 of brazing material which in this illustrative embodiment is a Titanium alloy consisting of 60% Ti, 25% Cu and 15% Ni. In some embodiments, the weight and/or mass of either of the feedthrough component 115 and/or the mounting flange 110 is less than 0.05 grams.

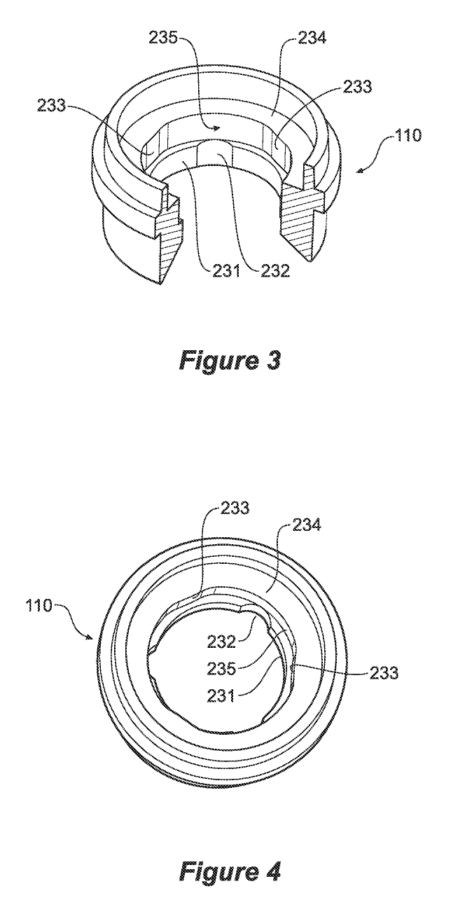

Referring now to FIGS. 3 and 4, there are shown detailed perspective views of mounting flange 110 which at its bottom end includes an inwardly extending ledge portion 231 which matches complementary circumferential recess region 117 located on the bottom end of feedthrough component 115 (as best seen in FIG. 2). In this illustrative embodiment, ledge portion 231 functions to both locate and support feedthrough component 115 within mounting flange 110 on assembly. Ledge portion 231 in this illustrative embodiment also includes three regularly spaced arcuate shaped cut-outs 232.

The inner sidewall or surface 235 of mounting flange 110 further includes three inwardly extending arcuate projection members 233 forming a generally trilobular arrangement which on assembly abuts the outer surface 118 of feedthrough component 115, thereby centrally locating feedthrough component 115 within mounting flange 110. Mounting flange 110 also includes an upper shoulder portion 234 which functions as a seating region to seat collar 210 and washers 220 on assembly.

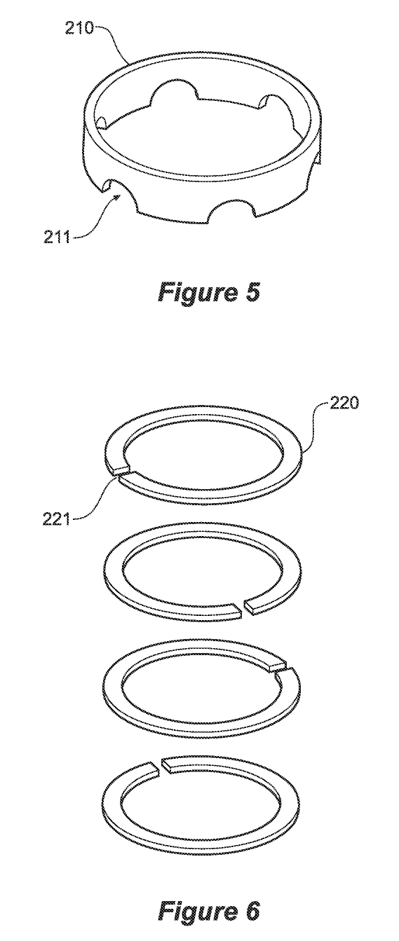

Referring now to FIG. 5, there is shown a detail perspective view of collar member 210 which on assembly seats on upper shoulder portion 234 of mounting flange 110. Collar member 210 includes six regularly spaced semicircular cut-out regions 211. As shown in FIG. 6, the brazing material is deployed as a number of circular washers 220 each incorporating a slit 221 which allows the washers 220 to be flexed when placed around collar member 210 on assembly. In this illustrative embodiment, each washer is 0.1 mm thick.

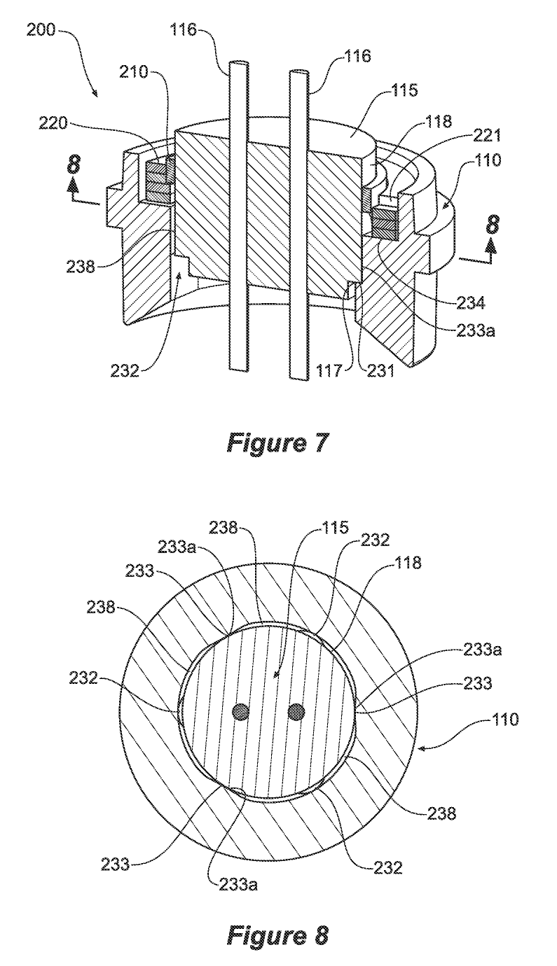

Referring now to FIG. 7, there is shown a formed assembly 200 prior to heating in an oven. Feedthrough component 115 is first positioned in mounting flange 110 via aperture 230 so that recess region 117 of feedthrough 115 is supported by ledge portion 231 of mounting flange 110, thereby locating the feedthrough component 115 within mounting flange 110 in a vertical sense. As can be seen in the sectional view of formed assembly 200 depicted in FIG. 8, inwardly extending arcuate projection members 233 formed in the sidewall or inner surface 235 of mounting collar 110 form a slight interference fit or press fit arrangement at three spaced locations 233a with the outer surface 118 of feedthrough component 115. This functions to locate the feedthrough component 115 within the mounting flange 110 in a horizontal sense.

In this example, where mounting collar 110 is of a generally cylindrical configuration, this horizontal positioning corresponds to location in a radial sense within mounting flange 110. Accordingly, in this embodiment projection members 233 in combination with ledge portion 231 position feedthrough component 115 to provide a precise gap 238 between the outer surface 118 of the feedthrough component 115 and the inner surface 235 of the mounting flange 110.

In this illustrative embodiment, gap 238 is of the order of 15 microns, and at least less than 20 microns, which as would be appreciated by those of skill in the art is significantly smaller than corresponding spacing in prior art feedthroughs such as the feedthrough described in International Patent Application Publication No. WO 2007/070989, which is of the order of 50-70 microns. Accordingly, the attainable positioning tolerance in the brazing process in this illustrative embodiment is in the order of a few microns in the radial dimension.

Collar 210 is then placed over the top portion of feedthrough component 115 and seats on shoulder portion 234 of mounting flange 110. The stackable washers 220 are then placed over the collar 210 with the slits 221 of each washer 220 rotationally positioned 90 degrees with respect to each other. As previously described, the slit 221 allows the washer 220 to be flexed or stretched when being placed over collar 210 resulting in the washer 220 sitting tightly against collar 210 and assisting assembly prior to heating.

The assembled component is then placed in an infrared brazing oven and subjected to a predetermined time and temperature profile. In one illustrative embodiment, the temperature of the oven is raised in a controlled ramping stage up to a maximum temperature of 1010 degrees C. over a 20 minute time period and then held at this “hold” temperature for 5 minutes. The temperature is then lowered in a further controlled ramping stage to room temperature. The maximum hold temperature is selected to correspond to the temperature of the brazing material required to create a capillary melt flow and to take into account any thermal transfer or shielding effects that may arise from mounting apparatus within the oven.

A jig may be utilized to maintain the assembly of the flange and the feedthrough component vertical during the heating operation, and may also be used to more evenly dissipate heat around the assembly.

In an exemplary embodiment, heating liquefies the braze material (i.e., turns the braze material molten), and facing surfaces of the flange and the feedthrough component are fused together upon cooling of the braze material. The solidified braze material also fills in some or all voids between the flange and the feedthrough component. The braze material forms a hermetic seal between the surfaces. In an exemplary embodiment, the braze material completely surrounds a diameter of the feedthrough component.

In an exemplary embodiment of the present invention, localized heat sink strips may be embedded into the feedthrough component or otherwise attached to the feedthrough to enhance heat dissipation.

In an exemplary embodiment of the present invention, the liquefied braze material is capillarily confined between the feedthrough component 115 and the flange 110 and/or between those respective components and the titanium collar 210. In an exemplary embodiment of the present invention, a capillary meniscus extending from a surface of the feedthrough component 115 to the flange 110 and/or from those respective components to the titanium collar 210 may be formed, and may be present upon solidification of the braze material upon cooling. That is, a capillary meniscus is formed extending between the two components that are brazed together.

In addition, the controlled ramp up and down from the hold temperature may include further intermediate hold points to allow the components to reach thermal equilibrium.

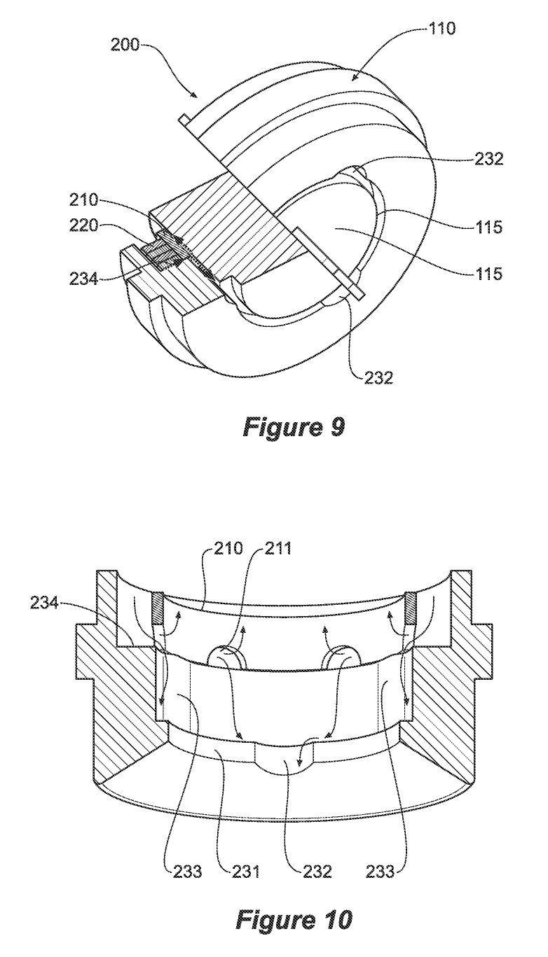

Referring now to FIGS. 9 and 10, there is shown various sectional views of the components of assembly 200 illustrating the direction of capillary flow of brazing material. Upon heating to the melt temperature of the stackable washers 220, the stackable washers 220 melt and are drawn by capillary action through the semicircle cut-out regions 211 of collar member 210 into gap 238.

During this process, ledge portion 231 of mounting flange 110 functions as a capillary flow diverter to divert or change the direction of the capillary flow in gap 238 of molten brazing material during the braze joining process by in this case providing a horizontal restraint plane. This promotes uniform capillary flow of brazing material between the feedthrough component 115 and the mounting flange 110 and has the added benefit of reducing the propensity of flooding of the feedthrough component 115 with brazing material.

In this illustrative embodiment, the ledge portion 231 further includes radially arranged semicircular cut-outs 232 which also function as air channels to promote diametrically even flow or more even flow of brazing material. Each cut-out 232 is the equivalent of 0.3 mm full circular radius and of equivalent thickness to the ledge portion 231. In this illustrative embodiment, cut-outs 232 are shifted 120° relative to the three arcuate projection members 233, this arrangement functioning to promote capillary pull of the molten braze material through ledge portion 231 (as is depicted by way of example in FIG. 10).

In this illustrative embodiment, gap 238 includes a further capillary flow diverter in the form of the inwardly extending arcuate projection members 233 that are formed in the sidewall or inner surface 235 of mounting flange 110 which function to divert or change the direction of capillary flow of brazing material and further evenly distribute this material onto ledge portion 231. As may be seen, the projection members 233 are located in the gap between the mounting flange 110 and the feedthrough component 115. It is noted that these projections may extend either from the mounting flange 110 or the feedthrough component 115, or both, in some embodiments. In an exemplary embodiment, the projection members 233 form a press fit or a slip fit arrangement between the mounting flange 110 and the feedthrough component 115.

In addition, this arrangement forms respective air channels between each of the arcuate projection members 233 which also function to promote even or more even capillary flow. In an exemplary embodiment, the capillary flow diverter also functions to locate the feedthrough component 115 vertically and/or horizontally within the mounting flange 110 during the joining operation. In an exemplary embodiment, the capillary flow diverter includes a ledge portion formed in the mounting flange 110 to support the feedthrough component 115 during the joining process. As will be understood, with reference to the gap 238, it is noted that in some embodiments of the present invention, at least one air channel can be formed combination with the capillary flow diverter to promote capillary flow of brazing material in the gap.

While in this illustrative embodiment the modifications in structure of the components to incorporate a capillary flow diverter arrangement or means in the gap 238 between them have been principally made in the mounting flange 100 (or first component), as will by now be inferred, in alternative embodiments, the capillary flow diverter arrangement can be implemented in part or in full in the received second component which in this case is the feedthrough component 115 which is received within the first component. As an example, the trilobular structure of the inwardly extending arcuate projection members 233 that are formed in the sidewall or inner surface 235 of mounting flange 110 could be implemented on the outer surface 118 of feedthrough component 115 or alternatively a number of interleaved structures could be formed alternatively on the inner and outer walls of the first and second components respectively to change the direction of capillary flow of brazing material and evenly distribute the volume of brazing material.

It is noted that while in prior brazing techniques, the flow of brazing material in the contact regions between the inner surface 235 of mounting flange and the outer surface 118 of feedthrough component 115 would have been believed to be restricted, embodiments of the present invention are implemented such that in these contact regions, there is a slight variation in the “contact” regions between these components such that perfect point contact between the respective surfaces is avoided. In an exemplary embodiment, this permits or otherwise enhances the flow of molten brazing material into these regions to form a braze join.

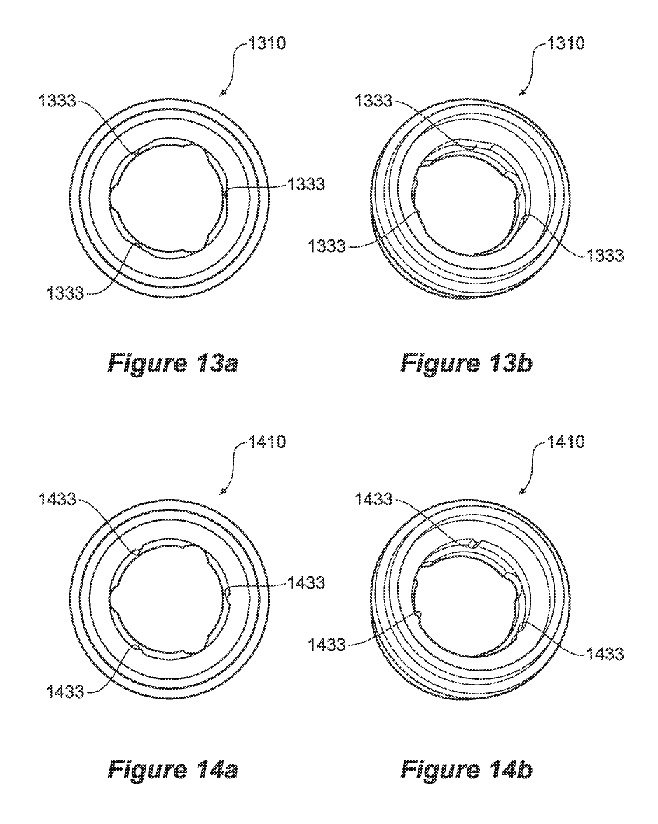

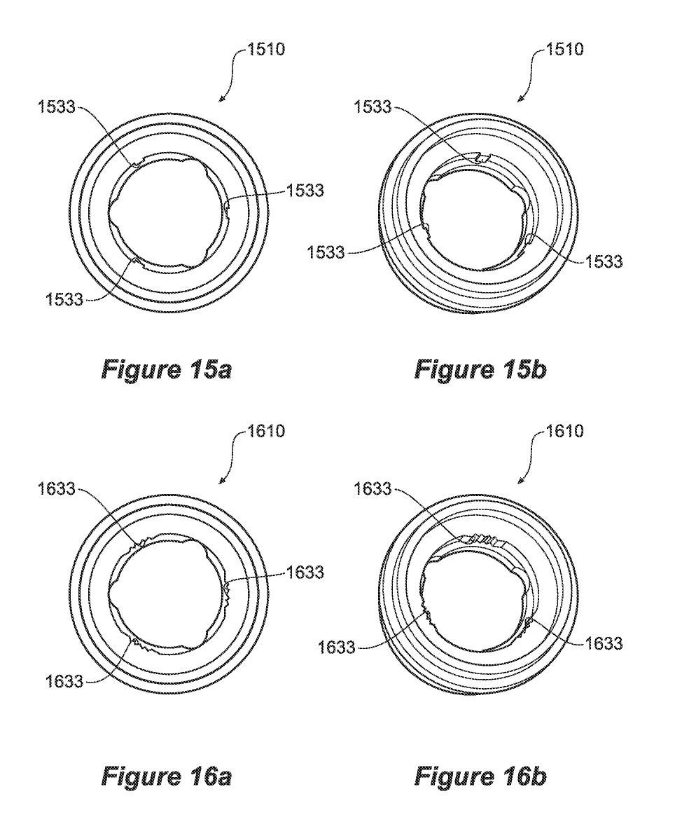

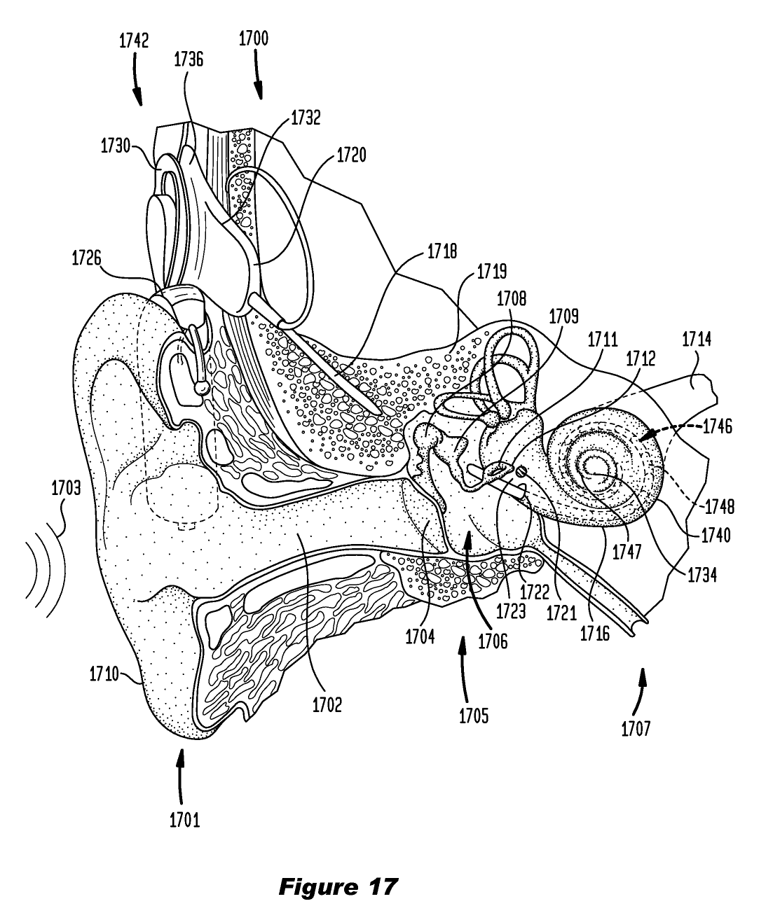

Referring now to FIGS. 13a to 16b, there are shown top plan and perspective views of mounting flanges 1310, 1410, 1510, 1610 respectively in accordance with further embodiments of the present invention. In the embodiments of FIGS. 13a and 13b the inwardly extending projection members are formed as straight chord like members 1333, while in the embodiments of FIGS. 14a and 14b, the inwardly extending projection members are formed as semi-circular rib members 1433. Similarly, in the embodiments of FIGS. 15a and 15b, the inwardly extending projection members are formed as flattened rib members 1533 whereas in the embodiments of FIGS. 16a and 16b, the inwardly extending projection members are in the form of angular serrations 1633. As would be appreciated by those skilled in the art, the number, size and shape of the inwardly extending projection members and more generally the capillary flow diverter may be modified according to requirements. In an exemplary embodiment any or all of these various components, and variations thereof, may be used in some or all of the brazing processes described herein.

While in the illustrative embodiments depicted in the Figures are such that the inwardly extending projection members extend generally along the length of the inner surface 235 of mounting flange 110, in other embodiments, these projection members may be a series of spaced elements either regularly or irregularly spaced about the inner surface 235 of mounting flange 110 and/or about the outer surface 118 of feedthrough component 115 to divert the direction of capillary flow of brazing material in gap 238. In a further embodiment, the outer surface of feedthrough component 115 may be roughened or otherwise formed to have a rough surface to provide an additional capillary flow diverter effect to divert the direction of capillary flow of brazing material.

While the illustrative embodiments presented above have been described with respect to circular components, in other embodiments of the present invention, components of other geometries including but not limited to square, rectangular, oval or complementary non regular geometries may be used.

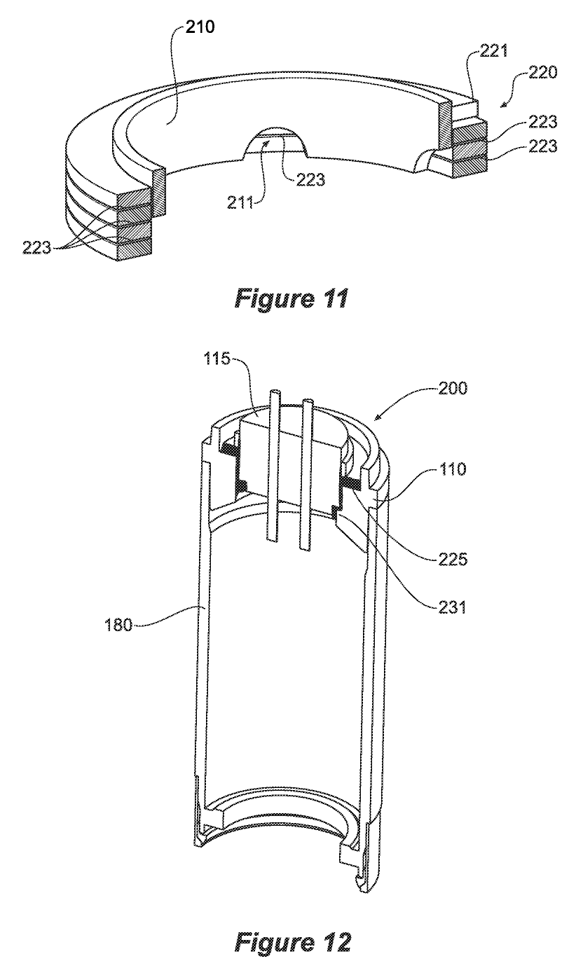

Referring now to FIG. 11, there is shown a sectional view depicting an arrangement of stackable washers 220 and collar member 210 in accordance with an illustrative embodiment of the present invention. In an exemplary embodiment employing a number of individual washers or more generally stackable members of brazing material that are configured to surround the received component, in contrast to a corresponding single washer of brazing material, the use of a number of individual stackable members or washers 220 of brazing material allows the amount of brazing material used to form the braze join to be controlled very precisely, at least more precisely with respect to the corresponding single washer of brazing material. In an exemplary embodiment, variations to the brazing process may be implemented including the removal or the addition of a single washer 220 or more than a single washer 220 to assembly 200, thereby precisely varying the volume of brazing material (in this case TiCuNi) available during the brazing process.

As shown in FIG. 11, the stacking of individual washers 220 may be such, in exemplary embodiments, to provide an air gap 223 between each washer 220 which also functions to promote even or more even melting and even or more even capillary flow of brazing material. As described previously, each stackable washer 220 may include an opening or slit 221 that facilitates the placing of individual washers 220 around collar member 210. In accordance with one illustrative embodiment of the present invention, four washers 220 are employed with the slit 221 of each washer 220 placed at an equiangular spacing offset with respect to each other (i.e. in this case 90 degrees as best seen in FIG. 6). This arrangement forms an air gap 223 at each layer which facilitates the even or more even melting and even or more even capillary flow of brazing material. As would be appreciated by those skilled in the art, this arrangement can be modified depending on the number of washers. In addition, the slit may cause each individual washer 220 to twist slightly which further accentuates air gaps 223 between each layer.

The formation of air gaps 223 in the brazing material may facilitate the capillary flow of the braze material as the air gaps provide a substantially increased surface area for heat to dissipate. This enhances the rapidity and extent of melting of the brazing material ensuring that the brazing material melts uniformly and becomes an homogeneous fluid pool of brazing material.

In another illustrative embodiment, the brazing material is in the form of a sponge incorporating internal air gaps or pockets, thereby further facilitating even or more even capillary flow of the brazing material. The sponge form of brazing material may be formed in one of many different ways including but not limited to, acid etching/bubbling of a sheet metal form of the stock brazing material, electro discharge machining (EDM) of the stock brazing material or high pressure micro blasting with grit of the stock brazing material.

Referring now to FIG. 12, there is shown the assembly 200 after a braze join has been formed between mounting flange 110 and feedthrough component 115 as further attached to the housing 180 of an implantable DACS actuator such as that referred to in FIG. 1. In accordance with an exemplary embodiment of the present invention, brazing material 225 has been drawn through collar member 210 and into the gap 238 between mounting flange 110 and feedthrough component 115, this capillary flow being diverted in this illustrative embodiment by ledge portion 231 and inwardly extending projection members 233 formed in the inner wall 235 of mounting flange 110 and further promoted by air channels in the form of circular cut-outs 232 in ledge portion 231 and between inwardly extending projection members 233. In this illustrative embodiment, ledge portion 231 and inwardly extending projection members 233 also function to locate feedthrough component 115 within mounting flange 110.

Some embodiments of the present invention are effective to provide a braze join which is suited to joining small scale components which otherwise would be subject to high thermal stresses. These high thermal stresses potentially causing defects in the components.

While the present invention has been described in one non limiting example with reference to the joining of a feedthrough component to a mounting flange in a DACS actuator, some or all embodiments of the present invention are applicable to other braze joins to reduce the effects of thermal stress introduced into one or more of the components being joined. As an example, an embodiment of the present invention could be applied to metal to metal joins, metal to glass joins, glass to glass joins or ceramic to ceramic joins and any braze material including gold alloys, various alloys of titanium including TiCuNi, TiNi, TiCuAg and silver alloys.

As detailed above, embodiments of the present invention may be utilized to fabricate a hearing prosthesis, which as detailed above, may be a DACS. Embodiments of the present invention may further be used to fabricate a cochlear prosthesis (commonly referred to as cochlear prosthetic devices, cochlear implants, cochlear devices, and the like; simply “cochlear implants” herein.) Cochlear implants deliver electrical stimulation to the cochlea of a recipient. As used herein, cochlear implants also include hearing prostheses that deliver electrical stimulation in combination with other types of stimulation, such as acoustic or mechanical stimulation (sometimes referred to as mixed-mode devices). It would be appreciated that embodiments of the present invention may be implemented in any cochlear implant or other hearing prosthesis now known or later developed, including auditory brain stimulators, or implantable hearing prostheses that mechanically stimulate components of the recipient's middle or inner ear.

FIG. 17 is perspective view of a cochlear implant, referred to as cochlear implant 1700, implanted in a recipient. The recipient has an outer ear 1701, a middle ear 1705 and an inner ear 1707. Components of outer ear 1701, middle ear 105 and inner ear 1707 are described below, followed by a description of cochlear implant 1700.

In a fully functional ear, outer ear 1701 comprises an auricle 1710 and an ear canal 1702. An acoustic pressure or sound wave 1703 is collected by auricle 1710 and channeled into and through ear canal 1702. Disposed across the distal end of ear cannel 1702 is a tympanic membrane 1704 which vibrates in response to sound wave 1703. This vibration is coupled to oval window or fenestra ovalis 1712 through three bones of middle ear 1705, collectively referred to as the ossicles 1706 and comprising the malleus 1708, the incus 1709 and the stapes 1711. Bones 1708, 1709 and 1711 of middle ear 1705 serve to filter and amplify sound wave 1703, causing oval window 1712 to articulate, or vibrate in response to vibration of tympanic membrane 1704. This vibration sets up waves of fluid motion of the perilymph within cochlea 1740. Such fluid motion, in turn, activates tiny hair cells (not shown) inside of cochlea 1740. Activation of the hair cells causes appropriate nerve impulses to be generated and transferred through the spiral ganglion cells (not shown) and auditory nerve 1714 to the brain (also not shown) where they are perceived as sound.

As shown, cochlear implant 1700 comprises one or more components which are temporarily or permanently implanted in the recipient. Cochlear implant 1700 is shown in FIG. 17 with an external device 1742 which, as described below, is configured to provide power to the cochlear implant.

In the illustrative arrangement of FIG. 17, external device 1742 may comprise a power source (not shown) disposed in a Behind-The-Ear (BTE) unit 1726. External device 1742 also includes components of a transcutaneous energy transfer link, referred to as an external energy transfer assembly. The transcutaneous energy transfer link is used to transfer power and/or data to cochlear implant 1700. As would be appreciated, various types of energy transfer, such as infrared (IR), electromagnetic, capacitive and inductive transfer, may be used to transfer the power and/or data from external device 1742 to cochlear implant 1700. In the illustrative embodiments of FIG. 17, the external energy transfer assembly comprises an external coil 1730 that forms part of an inductive radio frequency (RF) communication link. External coil 1730 is typically a wire antenna coil comprised of multiple turns of electrically insulated single-strand or multi-strand platinum or gold wire. External device 1742 also includes a magnet (not shown) positioned within the turns of wire of external coil 1730. It should be appreciated that the external device shown in FIG. 17 is merely illustrative, and other external devices may be used with embodiments of the present invention.

Cochlear implant 1700 comprises an internal energy transfer assembly 1732 which may be positioned in a recess of the temporal bone adjacent auricle 1710 of the recipient. As detailed below, internal energy transfer assembly 1732 is a component of the transcutaneous energy transfer link and receives power and/or data from external device 1742. In the illustrative embodiment, the energy transfer link comprises an inductive RF link, and internal energy transfer assembly 1732 comprises a primary internal coil 1736. Internal coil 1736 is typically a wire antenna coil comprised of multiple turns of electrically insulated single-strand or multi-strand platinum or gold wire. Positioned substantially within the wire coils is an implantable microphone system (not shown). As described in detail below, the implantable microphone assembly includes a microphone (not shown), and a magnet (also not shown) fixed relative to the internal coil.

Cochlear implant 1700 further comprises a main implantable component 1720 and an elongate electrode assembly 1718 extending from the main implantable component 1720. In embodiments of the present invention, internal energy transfer assembly 1732 and main implantable component 1720 are hermetically sealed within a biocompatible housing. In embodiments of the present invention, main implantable component 1720 includes a sound processing unit (not shown) to convert the sound signals received by the implantable microphone in internal energy transfer assembly 1732 to data signals, although in other embodiments, the sound processing unit may be located in the external components of the cochlear implant. Main implantable component 1720 further includes a stimulator unit (also not shown) which generates electrical stimulation signals based on the data signals. The electrical stimulation signals are delivered to the recipient via elongate electrode assembly 1718.

Elongate electrode assembly 1718 has a proximal end connected to main implantable component 1720, and a distal end implanted in cochlea 1740. In an exemplary embodiment, the electrode assembly 1718 is connected to the main implantable component 1720 via a feedthrough component, which may be manufactured according to the embodiments described herein. The feedthrough component permits the maintenance of the hermetic seal of the biocompatible housing just discussed, while permitting electrical signals to pass through the hermetic seal from/to the main implantable component 1720 to/from the electrode assembly 1718. In an exemplary embodiment, the flange brazed to the feedthrough component may be laser welded to the housing to attach the feedthrough to the housing. In embodiments of the present invention, internal energy transfer assembly 1732 and main implantable component 1720 are hermetically sealed within a biocompatible housing.

Electrode assembly 1718 extends from main implantable component 1720 to cochlea 1740 through mastoid bone 1719. In some embodiments electrode assembly 1718 may be implanted at least in basal region 1716, and sometimes further. For example, electrode assembly 1718 may extend towards apical end of cochlea 1740, referred to as cochlea apex 1734. In certain circumstances, electrode assembly 1718 may be inserted into cochlea 1740 via a cochleostomy 1722. In other circumstances, a cochleostomy may be formed through round window 1721, oval window 1712, the promontory 1723 or through an apical turn 1747 of cochlea 1740.

Electrode assembly 1718 comprises a longitudinally aligned and distally extending array 1746 of electrodes 1748, sometimes referred to as electrode array 1746 herein, disposed along a length thereof. Although electrode array 1746 may be disposed on electrode assembly 1718, in most practical applications, electrode array 1746 is integrated into electrode assembly 1718. As such, electrode array 1746 is referred to herein as being disposed in electrode assembly 1718. As noted, a stimulator unit generates stimulation signals which are applied by electrodes 1748 to cochlea 1740, thereby stimulating auditory nerve 1714.

Cochlear implant 1700 may comprises a totally implantable prosthesis that is capable of operating, at least for a period of time, without the need for external device 1742. Therefore, cochlear implant 1700 further comprises a rechargeable power source (not shown) that stores power received from external device 1742. The power source may comprise, for example, a rechargeable battery. During operation of cochlear implant 1700, the power stored by the power source is distributed to the various other implanted components as needed. The power source may be located in main implantable component 1720, or disposed in a separate implanted location.

The reference to any prior art in this specification is not, and should not be taken as, an acknowledgement of any form of suggestion that such prior art forms part of the common general knowledge.

The invention described and claimed herein is not to be limited in scope by the specific preferred embodiments herein disclosed, since these embodiments are intended as illustrations, and not limitations, of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A method for joining a first component to a second component with a brazing material, the first component including an aperture for receiving the second component, the method comprising:
positioning the second component within the first component via the aperture to form a gap between an inner surface of the first component and an outer surface of the second component;
introducing by capillary action brazing material into the gap between the first component and the second component; and
forming a join between the first and second component upon cooling of the brazing material introduced by capillary action,
wherein the capillary flow of brazing material in the gap is diverted via a capillary flow diverter located in the gap between the first and second component.

2. The method for joining a first component to a second component as claimed in claim 1, further comprising:
locating the second component within the first component via contact of the capillary flow diverter with the first and second components.

3. The method for joining a first component to a second component as claimed in claim 2, further comprising:
locating the second component vertically with respect to the first component via contact of the capillary flow diverter with the first and second components.

4. The method for joining a first component to a second component as claimed in claim 3, wherein the capillary flow diverter includes a ledge portion formed in the first component to support the second component via contact with the second component.

5. The method for joining a first component to a second component as claimed in claim 1, further comprising:
locating the second component horizontally with respect to the first component via contact of the capillary flow diverter with the first and second components.

6. The method for joining a first component to a second component as claimed in claim 5, wherein:
the capillary flow diverter includes a plurality of projection members located in the gap between the first component and the second component, the plurality of projection members extending from the inner surface of the first component and/or the outer surface of the second component.

7. The method for joining a first component to a second component as claimed in claim 6, wherein:
the action of positioning the second component within the first component results in a press fit between the first component and the second component at the interface of the plurality of projection members with the respective first component or the second component.

8. The method for joining a first component to a second component as claimed in claim 7, wherein:
the projection members are inwardly extending projecting members that extend inwardly from the inner surface of the first component towards the outer face of the second component.

9. The method for joining a first component to a second component as claimed in claim 1, further comprising:
promoting capillary flow of brazing material in the gap via at least one air channel in the gap operating in combination with the capillary flow diverter.

10. The method for joining a first component to a second component as claimed in claim 1, wherein:
the mass of the first component and/or the second component is less than 0.05 grams.

11. The method for joining a first component to a second component as claimed in claim 1, wherein:
the first component is a mounting flange and the second component is a feedthrough component sized, dimensioned and configured for use in an implantable component of a cochlear prosthesis to provide electrical communication from an interior of the implantable component to an electrode array exterior to the implantable component.

12. An assembly including a first component and a second component joined together with brazing material, the assembly comprising:
the first component including an aperture for receiving the second component,
the second component, the second component located within the first component;
an area between an inner surface of the first component and an outer surface of the second component, the area containing solidified braze material, the braze material joining the first component to the second component; and
a capillary flow diverter sized and dimensioned to divert capillary flow of liquefied brazing material in the area during the joining of the first component and the second component,
wherein a capillary meniscus extends from the surface of the first component to the surface of the second component.

13. The assembly as claimed in claim 12, wherein:
the capillary flow diverter includes a ledge portion formed in the first component and supporting the second component.

14. The assembly as claimed in claim 12, wherein:
the capillary flow diverter includes a plurality of projection members located in the area between the first component and the second component, the plurality of projection members extending from the inner surface of the first component and/or the outer surface of the second component.

15. The assembly as claimed in claim 12, wherein:
the mass of either the first component and/or the second component is less than 0.05 grams.

16. The assembly as claimed in claim 12, wherein:
the first component is a mounting flange and the second component is a feedthrough component of an implantable medical device.

17. A method for joining a first component to a second component with a brazing material, the first component including an aperture for receiving the second component, the method comprising:
positioning the second component within the first component via the aperture to form a gap between an inner surface of the first component and an outer surface of the second component;
stacking a plurality of braze material members at least one of about the second component or within the first component;
liquefying at least a portion of the braze material members; and
introducing by capillary action the brazing material into the gap between the first component and the second component.

18. A method for joining a first component to a second component as claimed in claim 17, further comprising:
surrounding a diameter of the second component with the plurality of stackable members.

19. A method for joining a first component to a second component as claimed in claim 17, wherein one or more of the stackable members includes a slit or spacing.

20. A method for joining a first component to a second component as claimed in claim 19, further comprising:
locating the slit or spacing of a first stackable member of the plurality of the stackable members rotationally offset from a location of the slit or spacing of a second stackable member of the stackable members.
